(19) United States
(12) Patent Application Publication
(10) Pub. No.: US 2026/0065677 A1
(43) Pub. Date: Mar. 5, 2026

(54) METHOD AND SYSTEM FOR SCENE SEGMENTATION USING INFORMATION ON ADJACENT SHOTS

(71) Applicant: CJ OliveNetworks Co., Ltd., Seoul (KR)

(72) Inventors: Jun Gu CHO, Seoul (KR); Seong Jong HA, Seoul (KR)

(21) Appl. No.: 19/317,075

(22) Filed: Sep. 2, 2025

(30) Foreign Application Priority Data
Sep. 3, 2024 (KR) 10-2024-0119464

(51) Int. Cl. G06V 20/40; G06V 10/26; G11B 27/34

(52) U.S. Cl. CPC G06V 20/49; G06V 10/26; G06V 20/48; G11B 27/34

(57) ABSTRACT

The present invention relates to a method of segmenting scenes in a video and a system therefor. Specifically, the present invention relates to a method and system for determining whether there is a transition between scenes and segmenting each of the scenes by extracting semantic characteristics of shots constituting a scene, particularly a specific shot and shots adjacent thereto, and comparing these characteristics.

### BACKGROUND OF THE INVENTION

### Field of the Invention

The present invention relates to a method of segmenting scenes in a video and a system therefor. Specifically, the present invention relates to a method and system for determining whether there is a transition between scenes and segmenting each of the scenes by extracting semantic characteristics of shots constituting a scene, particularly a specific shot and shots adjacent thereto, and comparing these characteristics.

### Background of the Related Art

Demands on production of new video contents by editing contents of a video in various ways are increasing. To this end, it is required first to separate scenes in a video, i.e., scenes directed to convey a specific meaning to viewers in the video. However, as the scene segmentation task requires precise understanding of the overall story of the video and the meaning or context that a scene desires to convey, most of the scene segmentation task is still is performed manually even today.

Meanwhile, as demands on production of new contents by utilizing original video contents increases, it has been attempted until recently to automate the process of segmenting scenes, but there is no sophisticated and automated solution yet.

The present invention has been conceived in consideration of the problematic situation described above, and relates to a method and system for automatically and accurately segmenting scenes by analyzing and comparing shots constituting a video, particularly adjacent shots.

### SUMMARY OF THE INVENTION

An object of the present invention is to automate and efficiently perform conventional scene segmentation tasks to efficiently segment scenes by grasping whether there is a transition of scenes using information on adjacent shots.

In particular, an object of the present invention is to embed and compare specific shots by reflecting contexts with respect to adjacent shots, as well as characteristics that can be extracted from the specific shots, and clearly distinguish boundaries between the scenes.

The present invention has been conceived to solve the problems described above, and according to one aspect of the present invention, there is provided a method of segmenting a scene by a system including a central processing unit and a memory, the method comprising the steps of: (a) receiving video contents; (b) segmenting a plurality of key frames included in a specific shot of the video contents into a plurality of patches, and generating a patch embedding by vectorizing each patch; (c) generating a shot embedding that reflects information on a specific shot of the video contents and adjacent shots existing to be adjacent to the specific shot with reference to the patch embedding, wherein the shot embedding is a vector matching the specific shot; and (d) calculating a probability value that the specific shot corresponds to a scene boundary on the basis of a shot embedding sequence configured of a plurality of consecutive shot embeddings.

In addition, the scene segmentation method may further comprise, after step (d), the step of (e) determining whether the specific shot corresponds to a scene boundary with reference to the probability value.

In addition, in the scene segmentation method, step (b) may include the steps of: segmenting each of the plurality of key frames included in a specific shot into a plurality of patches; generating a patch sequence by embedding the plurality of segmented patches; generating a patch embedding by adding a class token to the patch sequence; and adding a position embedding to the patch embedding.

In addition, in the scene segmentation method, step (c) may include the steps of: extracting intra context of the specific shot using the patch embedding; extracting inter context between the specific shot and at least one or more adjacent shots existing to be adjacent to the specific shot; and generating a shot embedding corresponding to the specific shot and representing characteristics of the specific shot and the at least one or more adjacent shots.

In addition, in the scene segmentation method, the intra context may be extracted by relationships among the plurality of patches included in the specific shot.

In addition, in the scene segmentation method, the inter context may be extracted by relationships between the specific shot and the at least one or more adjacent shots.

In addition, in the scene segmentation method, the step of extracting inter context may be performed through a Kuleshov mechanism, wherein the Kuleshov mechanism is a conversion mechanism that reflects a multi-head self-attention (MSA) layer, a multi-layer perception block, a layer normalization, a fully connected layer, and a Kuleshov window.

In addition, in the scene segmentation method, step (d) may be a step of receiving a shot embedding sequence as an input, and determining whether each shot is a boundary of a scene using the shot embedding sequence, wherein the shot embedding sequence is a set of a plurality of consecutive shot embeddings.

Meanwhile, according to another aspect of the present invention, there is provided a method of segmenting a scene by a system including a central processing unit and a memory, the method comprising the steps of: (a) receiving video contents without a scene label; (b) segmenting a plurality of key frames included in a specific shot of the video contents into a plurality of patches, and generating a patch embedding by vectorizing each patch; (c) generating a shot embedding that reflects information on a specific shot of the video contents and adjacent shots existing to be adjacent to the specific shot with reference to the patch embedding, wherein the shot embedding is a vector matching the specific shot; and (d) generating a pseudo boundary by searching for a semantic transition point within a shot sequence using duration information of the specific shot, wherein the shot sequence is configured of a plurality of arbitrary consecutive shots.

In addition, in the scene segmentation method, step (c) may include the steps of: extracting intra context of the specific shot using the patch embedding; extracting inter context between the specific shot and at least one or more adjacent shots existing to be adjacent to the specific shot; and generating a shot embedding corresponding to the specific shot and representing characteristics of the specific shot and the at least one or more adjacent shots.

In addition, in the scene segmentation method, the step of generating a pseudo boundary may include the steps of: segmenting the shot sequence into two non-overlapping sequences of a first subsequence and a second subsequence; determining a farther subsequence among the first subsequence and the second subsequence as an anchor shot on the basis of a temporal distance from the specific shot; calculating an optimal alignment value between the anchor shot and the shot sequence; and determining a pseudo boundary on the basis of a result of the calculation.

In addition, the scene segmentation method may further comprise, after step (d), the step of (e) calculating a probability value that the specific shot corresponds to a scene boundary on the basis of a shot embedding sequence configured of a plurality of consecutive shot embeddings.

Meanwhile, according to still another aspect of the present invention, there is provided a system including a central processing unit and a memory, the system comprising: a contents receiving unit for receiving arbitrary video contents from outside; a patch embedding unit for segmenting a plurality of key frames included in a specific shot of the video contents into a plurality of patches, and generating a patch embedding by vectorizing each patch; a shot encoding unit for generating a shot embedding that reflects information on a specific shot of the video contents and a plurality of shots including adjacent shots existing to be adjacent to the specific shot with reference to the patch embedding, wherein the shot embedding is a vector matching the specific shot; and a global context analysis unit for calculating a probability value that the specific shot corresponds to a scene boundary on the basis of a shot embedding sequence configured of a plurality of consecutive shot embeddings.

The system may further comprise a scene boundary determination unit for determining whether the specific shot is a scene boundary with reference to a probability value calculated by the global context analysis unit.

Meanwhile, according to still another aspect of the present invention, there is provided a system including a central processing unit and a memory, the system comprising: a contents receiving unit for receiving arbitrary video contents without a scene label from outside; a patch embedding unit for segmenting a plurality of key frames included in a specific shot of the video contents into a plurality of patches, and generating a patch embedding by vectorizing each patch; a shot encoding unit for generating a shot embedding that reflects information on a specific shot of the video contents and a plurality of shots including adjacent shots existing to be adjacent to the specific shot with reference to the patch embedding, wherein the shot embedding is a vector matching the specific shot; a pseudo boundary generation unit for generating a pseudo boundary by searching for a semantic transition point within a shot sequence using duration information of the specific shot, wherein the shot sequence is configured of a plurality of arbitrary consecutive shots; and a global context analysis unit for calculating a probability value that the specific shot corresponds to a scene boundary with reference to a shot embedding sequence configured of a plurality of consecutive shot embeddings and the pseudo boundary generated by the pseudo boundary generation unit.

### BRIEF DESCRIPTION OF THE DRAWINGS

FIG. 1 is a view for conceptual and easy understanding of a scene segmentation method and a system therefor according to the present invention.

FIG. 2 is a view showing a system according to an embodiment of the present invention.

FIG. 3 is a flowchart sequentially illustrating a scene segmentation method according to a first embodiment of the present invention.

FIG. 4 is a view showing a process of generating a patch embedding from key frames included in a specific shot.

FIG. 5 is a view for explaining a mechanism executed in a shot encoding unit.

FIG. 6 a flowchart illustrating a process of generating a shot embedding.

FIG. 7 is a flowchart sequentially illustrating a scene segmentation method according to a second embodiment of the present invention.

FIG. 8 is a view showing a pseudo boundary generation step in detail.

FIGS. 9(a) and 9(b) are a view comparing a reference that segments arbitrary video contents by actual scenes with a scene segmentation result acquired when the present invention is used.

### DETAILED DESCRIPTION OF THE PREFERRED EMBODIMENT

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

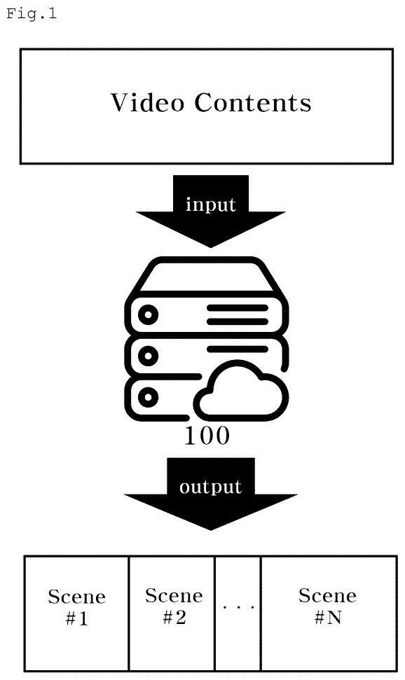

FIG. 1 is a view for conceptual understanding of a scene segmentation method and a system therefor according to the present invention. Referring to the drawing, the present invention uses a basic utilization example, in which when contents, i.e., the subject of a scene segmentation task, for example, when certain video contents are input into the system 100, a result of the scene segmentation of the video contents is provided to the user.

For example, when there are 2-hour movie contents, a label about the time point of scene transition does not exist at all in the movie contents unless the movie contents are not video data generally possessed by an editing entity. Movie contents that do not have any label at all are an unsuitable source for subsequently generating new contents (e.g., highlight video), and when it is desired to produce new contents, a task of segmenting each scene of the movie contents should be performed by spending additional manpower and cost.

However, as shown in the drawing, the scene segmentation method and system according to the present invention allows automatic and accurate scene segmentation when certain video contents, more specifically, video contents without a scene label are input and allows the user to utilize a result thereof so that each scene of the video contents can be edited easily.

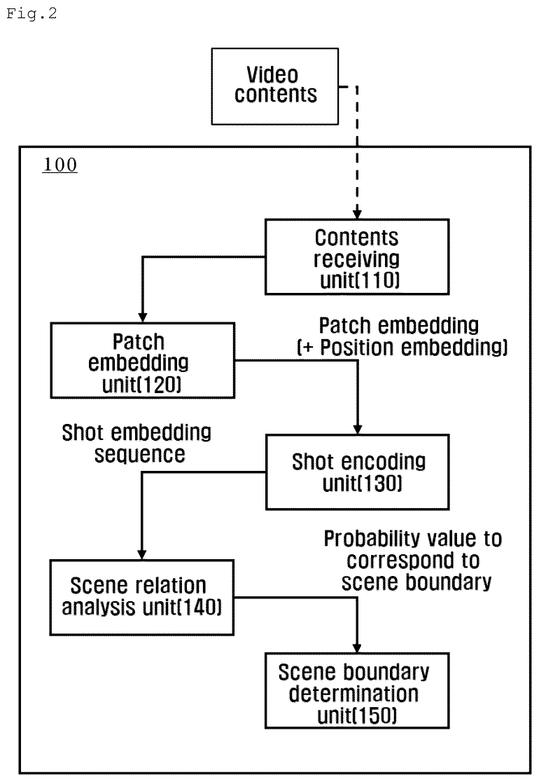

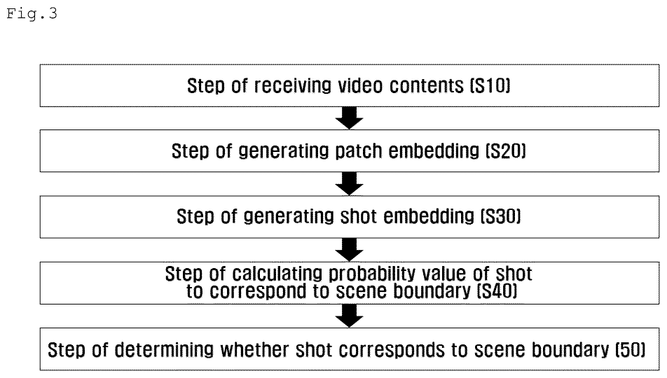

FIG. 2 is a view schematically showing a scene segmentation system 100 according to an embodiment of the present invention, and FIG. 3 is a view showing a scene segmentation method according to an embodiment of the present invention step by step.

Before describing in detail, it should be understood that the scene segmentation method according to the present invention may be executed by a system or computing device having a central processing unit and a memory. The type of the system or computing device may include both portable terminals such as a smart phone, a PDA, and a tablet PC, and terminals fixedly placed in a predetermined location such as a desktop PC. The central processing unit may also be referred to as a controller, a microcontroller, a microprocessor, a microcomputer, or the like. In addition, the central processing unit may be implemented as hardware, firmware, software, or a combination thereof. In the case of implementing the method using hardware, the central processing unit may be implemented as an application specific integrated circuit (ASIC), a digital signal processor (DSP), a digital signal processing device (DSPD), a programmable logic device (PLD), a field programmable gate array (FPGA), or the like, and in the case of implementing the method using firmware or software, the firmware or software may be configured to include modules, procedures, functions, and the like that perform the functions or operations described above. In addition, the memory may be implemented as Read Only Memory (ROM), Random Access Memory (RAM), Erasable Programmable Read Only Memory (EPROM), Electrically Erasable Programmable Read-Only Memory (EEPROM), flash memory, Static RAM (SRAM), Hard Disk Drive (HDD), Solid State Drive (SSD), or the like.

Meanwhile, in some cases, the system may be a server, and in this case, the server may be a device that stores and executes a program, i.e., a set of instructions, for actually implementing the scene segmentation method according to the present invention. The server may be at least in the form of one server PC managed by a specific user, or may be in the form of a cloud server provided by another company, i.e., a cloud server that a user may use after registering as a member.

In addition, in some cases, the scene segmentation method according to the present invention may be executed on a cluster system configured of a plurality of systems or computing devices rather than a single system. Within the cluster system, a plurality of computing devices needed to execute the scene segmentation method may be set to perform different operations, respectively.

Referring to FIG. 2, the scene segmentation system 100 according to the present invention may include a contents receiving unit 110, a patch embedding unit 120, a shot encoding unit 130, a unit 140, and a global context analysis scene boundary determination unit 150. The function of each component will be described with reference to FIG. 3.

Referring to FIG. 3, the scene segmentation method may first include a step of receiving contents that will be a target of a scene segmentation task, i.e., video contents (S10). This step may be performed through the contents receiving unit 110, and the received video contents may include video files, real-time streaming videos, or recorded videos of various formats (e.g., MP4, AVI, MKV, etc.), and in addition, the method of receiving the contents may also include various methods, such as direct input into the system using a storage medium (e.g., USB or the like) or input through a network. As briefly mentioned in the description of FIG. 1, the received video contents may be ones in which scenes therein are not distinguished, i.e., ones in which it is unknow at all which scene exists in which section as there is no scene label.

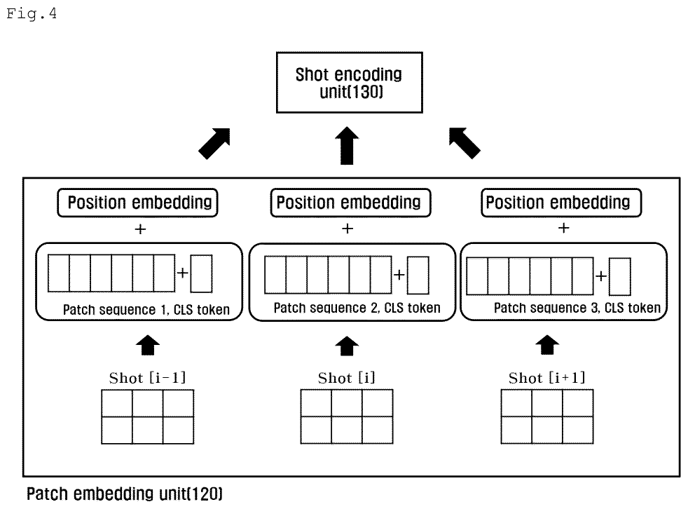

After step S10, the scene segmentation method may include a step of generating a patch sequence from some key frames acquired from the video contents (S20), and this will be described with reference to FIG. 4.

This step may be performed by the patch embedding unit 120, and the patch embedding unit 120 generates a patch sequence for each of a plurality of input shots (Shot [i−1], Shot [i], Shot [i+1]).

Referring to the drawing, first of all, the patch embedding unit 120 may extract key frames, which are representative images, from each shot. At this point, the key frames of each shot are images that implicitly express the contents of the shot, and a plurality of key frames may be extracted in order of time.

Subsequently, the patch embedding unit 120 may segment each extracted key frame into patches, i.e., small image fragments of a predetermined size. The size of the patches may be randomly set according to design of the algorithm, and for example, a key frame may be segmented into patches of 16×16 pixel size.

Next, the patch embedding unit 120 may convert each of the segmented patches in a D-dimensional vector form, and the converted vectors may include values representing visual characteristics of each patch. For convenience, a set of patches converted in a vector form will be referred to as a patch sequence. In the drawing, it can be confirmed that a patch sequence (patch sequences 1 to 3) is generated for each shot.

Thereafter, the patch embedding unit 120 may add a class token (CLS token), which will be used for representing the overall characteristics of a corresponding shot, to each patch sequence, and at this point, the class token summarizes the overall information on the shot and may be used later by the shot encoding unit 130 to generate a shot embedding. For reference, the patch sequence mentioned above may also be understood as a patch embedding, and it is understood that a patch sequence of a state including the added class token may also be included in the concept of the patch embedding. That is, in this detailed description, a set of vector-converted patches may be referred to as a patch sequence or a patch embedding, and a patch sequence of a state including the added class token may also be understood as a patch embedding.

In addition, the patch embedding unit 120 may add a position embedding, i.e., a vector containing information indicating the position of each patch within the key frame, to each patch embedding, and this is intended to know the characteristic of the position of the patch within the scene, in addition to the visual characteristics of the patch.

As a result, the patch embedding unit 120 may extract key frames from video contents including even the position embedding, and then generate a patch embedding, i.e., a patch embedding of a state including the added position embedding, for each key frame.

In addition, the patch embeddings generated by the patch embedding unit 120 may be input into the subsequent shot encoding unit 130 in the form of a patch embedding sequence, i.e., a tensor in which the patch embeddings are structured as a multidimensional array.

This may be expressed as an equation shown below.

$$\begin{matrix}{k}_{i} ∈ {ℝ}^{C \times H \times W} \\ L = HW / {p}^{2} \\ {s}_{i} ∈ {ℝ}^{M \times C \times H \times W} \\ {x}_{i} ∈ {ℝ}^{( M ( 1 + L ) ) \times D}\end{matrix} \qquad [ Equation 1 ]$$

That is, when a key frame called ki may be expressed as a state including real values of C (channel; color), H (height; number of vertical pixels), and W (width; number of horizontal pixels), each key frame may be divided into L patches having a p×p size, and when a shot (scene) including these key frames is referred to as sᵢ, each shot may be converted into a patch embedding sequence called xᵢ, i.e., a tensor, by the patch embedding unit 120. For reference, (1+L) indicates that 1 is added to the value of the number of patches (L) as a class token (CLS token) is added for each key frame, and D indicates the dimension of the vector.

In this way, the patch embedding unit 120 may generate a series of patch embedding sequences from the extracted key frames.

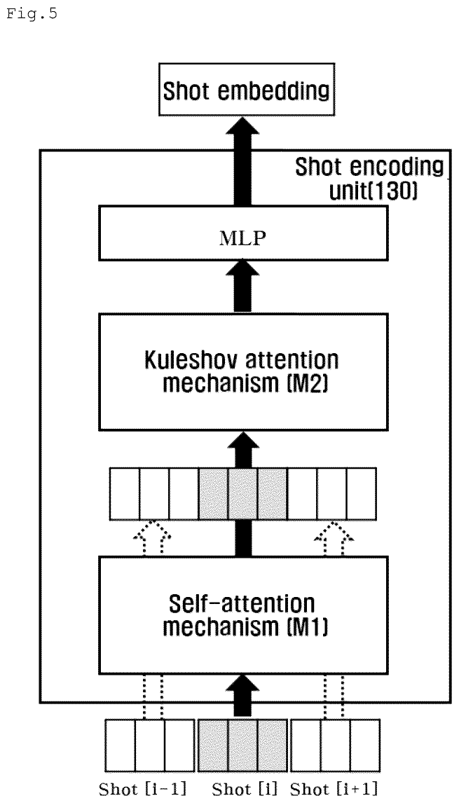

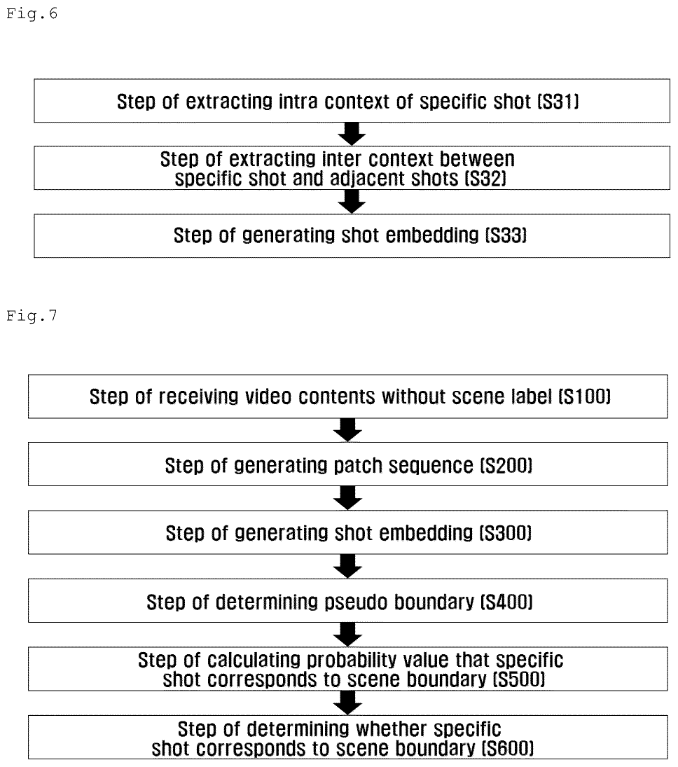

After step S20, the scene segmentation method may include a step of generating a shot embedding by the shot encoding unit 130 with reference to the previously generated patch embedding sequence (S30). FIGS. 5 and 6 are views for explaining the operation process in the shot encoding unit 130. FIG. 5 is a view for explaining a mechanism for generating a shot embedding inside the shot encoding unit 130, and FIG. 6 is a flowchart illustrating the step of generating a shot embedding (S30) in detail.

First, referring to FIG. 6, the step of generating a shot embedding (S30) may largely include a step of extracting intra context of a specific shot (S31), a step of extracting inter context between the specific shot and adjacent shots (S32), and a step of generating a shot embedding (S33). The intra context refers to information that can be acquired from the specific shot itself, and may include information indicating frame(s) constituting a corresponding shot (scene), and various elements included in the shot and relationships between them. For example, changes in the facial expression of a person, movement of a camera, and the like may be included. On the contrary, the inter context refers to information that can be acquired from the relationship between a specific shot and adjacent shots, and information indicating temporal flows between shots, semantic connection relationships between shots, and the like may be included. For example, information on the change in the position of a person, change in the location, and change in the time between two shots may be included. That is, at the step of generating a shot embedding, the intra context is extracted first from individual shots, the inter context between the shots is extracted, and then a shot embedding is generated to include all of the information.

Referring to FIG. 5, two attention mechanisms may be internally executed in the shot encoding unit 130. To help intuitive understanding of the mechanisms in this detailed description, the first attention mechanism will be referred to as a self-attention mechanism M1, and the second attention mechanism will be referred to as a Kuleshov attention mechanism M2.

The shot encoding unit 130 may receive the patch embedding sequence generated by the patch embedding unit 120 as an input and execute the self-attention mechanism on the basis of the received patch embedding sequence, and extract intra context by executing the self-attention mechanism. It is mentioned above that one specific shot includes several key frames and each key frame may be segmented into small patches, and the self-attention mechanism in the shot encoding unit 130 may extract intra context of the specific shot, i.e., characteristics of the scene itself, by grasping the relationships between these patches. A first shot embedding may be generated as a result of executing the self-attention mechanism, and the first shot embedding may be utilized as an input for executing the second attention mechanism, i.e., the Kuleshov attention mechanism M2.

The Kuleshov attention mechanism has been proposed based on the motivation of the Kuleshov effect, i.e., the fact that the meaning of a specific shot may be changed or interpreted in a different way according to the shots existing before or after the shot (scene), and the Kuleshov attention mechanism in the present invention is a mechanism for extracting characteristics of a specific shot considering even the relationships with adjacent shots, as well as information on the specific shot itself. As the meaning of the specific shot may be extracted by reflecting even the information on the adjacent shots through the Kuleshov attention mechanism, the meaning of the specific shot may be grasped more accurately, and there is an effect of grasping the time point of scene transition, i.e., the boundary of scenes, more accurately.

Execution of the Kuleshov attention mechanism may be accomplished according to equations 2 and 3 shown below.

$${f}_{K A} ( {x}_{i} , j ) = FC ( MSA ( LN ( {U}_{k w , j} ( {x}_{i} ) ) ) ) \qquad [ Equation 2 ]$$

$$s . t . {U}_{kw , j} ( {x}_{i} ) = [ {x}_{i - j} , … , {x}_{i} , … , {x}_{i + j} ]$$

In the above equation, U_{kw,j}(xᵢ) is a function that defines the Kuleshov window (the range of shots of which the relationships are explored), and this is to define j adjacent shots on the left and right side of a specific shot xᵢ as the Kuleshov window. For example, when j has a value of 1, the Kuleshov window will include Shot [i−1], Shot [i], and Shot [i+1] as shown in FIGS. 4 and 5. Meanwhile, Layer Normalization (LN) may refer to a function for layer normalization, Multi-Head Self-Attention (MSA) may refer to a function that extracts information on the relationship between shots included in the Kuleshov window, and Fully Connected layer (FC) may refer to a function that converts or generates a result produced by the MSA as a vector of another dimension.

That is, referring to the above equation, it can be confirmed that the Kuleshov attention mechanism generates a vector reflecting information on adjacent shots, i.e., shot embedding, by applying the Kuleshov window to the i-th shot. For convenience, the shot embedding converted by the Kuleshov attention mechanism will be referred to as a second shot embedding.

After the Kuleshov attention mechanism is executed, the Multi-Layer Perceptron (MLP) may be executed, and the second-shot embedding may be converted into a third shot embedding by executing the MLP function.

The step of generating a shot embedding (S30) discussed above may be mathematically expressed as shown below.

$${x}_{i}^{′} = M S A ( L N ( {x}_{i} ) ) + {x}_{i} \qquad [ Equation 3 ]$$

$$where$$

$${x}_{i} ∈ {ℝ}^{( M ( 1 + L ) ) \times D}$$

$$x {}_{i}^{″} = {f}_{K A} ( {x}_{i}^{′} , j ) + {x}_{i}^{′} ,$$

$${z}_{i} = MLP ( LN ( x {}_{i}^{″} ) ) + x {}_{i}^{″}$$

First, the shot encoding unit 130 may extract intra context xᵢ′ of a specific shot received as an input on the basis of tensor xᵢ of the specific shot by executing the self-attention mechanism. In this process, the Multi-Head Self-Attention (MSA) function and the Layer Normalization (LN) function may be utilized.

Next, the shot encoding unit 130 may extract inter context xᵢ″ between adjacent shots on the basis of xᵢ′ received as an input by executing the Kuleshov attention mechanism. Since the Kuleshov attention mechanism has been described above in detail, detailed description thereof will be omitted.

Finally, the shot encoding unit 130 may generate the final shot embedding (third shot embedding) zᵢ on the basis of xᵢ″ received as an input by executing the MLP function.

Meanwhile, after the shot embedding is generated, the system 100, more specifically, the global context analysis unit 140 may calculate a probability value of the specific shot to correspond to a scene boundary (S40) with reference to the shot embedding sequence. The global context analysis unit 140 calculates the probability of each shot for corresponding to a scene boundary by modeling the relationships between a series of shots, and this calculation may include a process of extracting long-term context between shots by using a BERT-based model, and calculating the probability of each shot for corresponding to a scene boundary on the basis of the extracted long-term context.

Next, the probability value calculated in the previous step may be utilized by the scene boundary determination unit 150 to determine whether the shot corresponds to a scene boundary (S50). When the probability value of a specific shot for corresponding to a scene boundary exceeds a reference value, the shot may be determined as a scene boundary, and when the probability value is lower than the reference value, the shot may be determined as not a scene boundary.

A method of segmenting a scene by the system according to the present invention has been described above with reference to FIGS. 2 to 6.

FIG. 7 is a flowchart illustrating a second embodiment in order. Referring to the drawing, steps S100 to S300 are substantially the same as steps S10 to S30 in FIG. 3 described above.

On the assumption that S100 to S300 are substantially the same as S10 to S30 described above, a second embodiment may further include a step of generating a pseudo boundary (S400). At step S300, consecutive shot embeddings, i.e., a shot embedding sequence, may be acquired, and this step may also be understood as a step of determining a point at which scene transition is most likely to occur between a series of scenes, i.e., a semantic transition point, by utilizing the shot embeddings, particularly the duration information of each shot. Generally, video contents are configured several of shots (scenes), and for scene segmentation, it is very important to find a specific time point at which scene transition occurs within a series of shots (scenes). To this end, the second embodiment includes a step of finding a time point when it is highly likely to be a pseudo boundary, i.e., a boundary between scenes, and defining the point as a pseudo boundary, and in particular, the pseudo boundary is calculated after defining shots on both sides, which are farthest within a predetermined threshold on the basis of the temporal distance from a specific shot, as an anchor sequence.

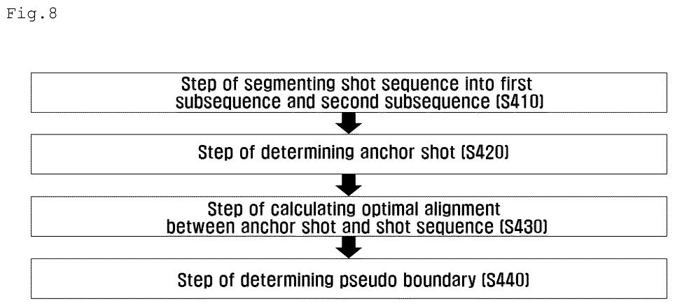

FIG. 8 is a view for specifically explaining step S400, and referring to the drawing, step S400 may include a step of segmenting a shot sequence configured of a plurality of arbitrary consecutive shots into two non-overlapping sequences of a first subsequence and a second subsequence (S410), a step of determining a farther subsequence among the first subsequence and the second subsequence as an anchor shot on the basis of the temporal distance from a specific shot (S420), a step of calculating an optimal alignment between the anchor shot and the shot sequence (S430), and a step of determining a pseudo boundary on the basis of a result of the calculation (S440).

Steps S410 and S420 may be understood as the steps of segmenting a shot sequence into two subsequences, and determining an anchor shot sequence Sᵢ^{a}={sₗ. sᵣ} from the subsequences. sₗ refers to a shot farthest away from the reference target shot sᵢ among the shots on the left side within a specific time distance Dₜₕᵣ (a value that can be set randomly), and on the contrary, sᵣ refers to a shot farthest away from the reference target shot sᵢ among the shots on the right side. That is, the anchor shot sequence may be defined as a set of anchor shots, i.e., two shots temporally farthest away from the target shot sₗ. For reference, the process of obtaining the l value and r value may be expressed as an equation shown below.

$$l = j = {i - W , … ,}^{argmin} i - 1 {\sum }_{k = j}^{i - 1} {d}_{k} < {D}_{thr} , \qquad [ Equation 4 ]$$

$$r = j = {i + 1 , …}^{argmax} , i + W \sum {}_{k = i + 1}^{j} {d}_{k} < {D}_{thr ,}$$

In the above equations, dk represents the duration of the k-th shot, the l value may be defined as the index of the leftmost shot among the shots (scenes) on the left side of the target shot sᵢ, of which the cumulative duration from the target shot is smaller than Dₜₕᵣ, and the r value may be defined as the index of the rightmost shot among the shots (scenes) on the right side of the target shot sᵢ, of which the cumulative duration is smaller than Dₜₕᵣ.

After the anchor shot sequence is determined in this way, the steps of finding a pseudo boundary through an optimal alignment between the anchor shot and the shot sequence (S430, S440) is performed, and this may be performed according to the equation shown below.

$$b *= {b = - W , … , W - 1}^{argmax} \text{} ( \frac{1}{b + W + 1} {\sum }_{j = - W}^{b} sim ( {e}_{l} , {e}_{i + j} ) + \frac{1}{- b + W} {\sum }_{j = b + 1}^{W} sim ( {e}_{r} , {e}_{i + j} ) ) \qquad [ Equation 5 ]$$

In the above equation, b* represents a pseudo boundary point, i.e., a position of a shot highly likely to be a boundary between scenes within the shot sequence sᵢ, sim(x, y) represents a function that calculates cosine similarity between shot embeddings of two shots x and y, eₗ represents the shot embedding of the left anchor shot, eᵣ represents the shot embedding of the right anchor shot, and eᵢ₊ⱼ represents the shot embedding of a shot that is away from sᵢ as much as j. Seeing the above equation on the basis of this, it can be seen that the above equation divides a set of shots similar to the anchor shot sₗ on the left side from a set of shots similar to the anchor shot sᵣ on the right side, calculates an average similarity of the shot embeddings in each set, finds the b value when the sum of the average similarities is maximized (argmax), and determines the value as the pseudo boundary. That is, as a point where the difference in the shot embedding similarity between the two sides is the greatest is found through an optimal alignment operation, it is predicted that the shot sequences on both sides of that point are highly likely to belong to different scenes.

Meanwhile, after the pseudo boundary is determined in the way as described above, the system 100 may perform a step of calculating a probability value of a specific shot to correspond to a scene boundary (S500), and a step of determining whether a specific shot corresponds to a scene boundary (S600).

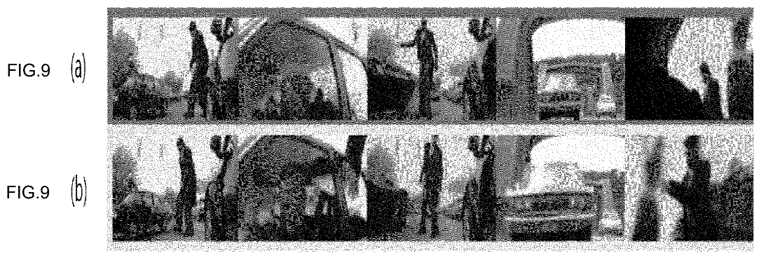

FIG. 9 is a view showing an example that confirms how accurate an obtained result can be when the scene segmentation method according to the present invention is used. In the drawing, (a) is a view separately displaying the points where scenes are actually changed within arbitrary movie contents, and (b) is a view showing scenes segmented at the points where semantic changes occur by the scene segmentation method according to the present invention. Comparing the results, it can be seen that the result of the scene segmentation method according to the present invention is not significantly different from the result of the scene segmentation accurately performed by a human.

The scene segmentation method according to the present invention has been described above with reference to the drawings.

Meanwhile, the scene segmentation method described above relates to a process of segmenting arbitrary video contents into a plurality of scenes when the video contents are input into the system 100, and it is assumed that the scene segmentation method is executed by a series of learned algorithms.

Pre-training of training the characteristics of shots (scenes) may be performed on the algorithms for executing the scene segmentation method using a large amount of unlabeled video data, and fine-tuning of training to grasp the scene boundaries may be performed using labeled datasets. These pre-training and fine-tuning are needed since a lot of cost is required to acquire a correct answer for the scene boundaries that will be used for training.

At the pre-training step, training is performed using a large amount of data that does not have a correct answer, and as there is no correct answer, the training is performed by utilizing the characteristics that the data has or values defined for specific purposes. The present invention defines a pseudo boundary and utilizes it in the pre-training step.

The pre-learning process may include a step of acquiring a shot embedding sequence (local context embedding sequence) through the shot encoding unit 130, and a step of acquiring a context sequence (representation sequence with global context) through the global context analysis unit 140.

Meanwhile, when it is assumed that the pseudo boundary is a correct answer data utilized at the pre-training step, a loss function specifies how to train the algorithm, and a loss function including at least four loss terms may be used in the pre-training process. Specifically, three shot-level expression losses, i.e., Shot-Scene Matching (LSSM), Contextual Group Matching (LCGM), and Pseudo-boundary Prediction (LPP) loss terms, may be included, and one sequence-level loss, i.e., Masked Shot Modeling, may be included.

The shot-scene matching is a loss function that induces the average of the embedding vectors of shots in each sequence to be close to the embedding vector of the anchor shot of the sequence, for the scene sequences (l, r) on both sides on the basis of a pseudo boundary. When it is assumed that the average of the embedding vectors is a representative expression (or vector) of the sequence, the meaning that the anchor shot become similar to the embedding means as a result that as the shots within a scene sequence are clustered to be close within the embedding space, it is easy to distinguish shots of different scenes.

The shot-scene matching loss term may be calculated according to the equation shown below, and this may be utilized to learn to increase the similarity between shots and scenes on the basis of a pseudo boundary.

$${ℒ}_{S S M} = {ℒ}_{N C E} ( {h}_{S S M} ( {e}_{l} ) , {h}_{S S M} ( \frac{1}{W - b * + 1} \sum {E}_{i}^{l} ) ) + {ℒ}_{N C E} ( {h}_{S S M} ( {e}_{r} ) , {h}_{S S M} ( \frac{1}{W - ( b * + 1 ) + 1} \sum {E}_{i}^{r} ) ) \qquad [ Equation 6 ]$$

In the above equation, h_{SSM} may be defined as a function that converts a shot embedding into a scene embedding, and referring to this, it can be seen that the above equation is a loss function that produces a value obtained by adding the similarity between the average embeddings of the anchor shot eₗ on the left side and shots existing on the left side of the pseudo boundary b*, and the similarity between the average embeddings of the anchor shot eᵣ on the right side and the shots existing on the right side of the pseudo boundary b*.

The contextual group matching means inducing the target shot to have an embedding similar to the vectors in the same sequence by utilizing arbitrary shots (positive) included in the same sequence and arbitrary shots (negative) not included in the same sequence on the basis of a pseudo boundary. The algorithm may learn whether or not a corresponding shot is a scene boundary through the embedding result of the target shot.

The context group matching loss term may be calculated according to the equation shown below, and this may be utilized to learn to increase the contextual similarity between shots belonging to the same scene on the basis of a pseudo boundary.

$${ℒ}_{C G M} = - log ( {h}_{CGM} ( {e}_{i}^{′} , {e}_{p o s}^{′} ) ) - log ( 1 - {h}_{C G M} ( {e}_{i}^{′} , {e}_{n e g}^{′} ) ) \qquad [ Equation 7 ]$$

In the above equation, h_{CGM} may be defined as a function that converts a shot embedding into a context embedding, and referring to this, it can be seen that the above equation is a loss function that calculates a sum of a log loss term that represents the similarity between a specific shot embedding eᵢ and positive shots belonging to the same scene on the basis of a pseudo boundary, and a log loss term that represents the similarity between a specific shot embedding eᵢ and negative shots belonging to different scenes on the basis of a pseudo boundary.

Pseudo boundary prediction is distinct from actual scene boundaries, and the pseudo boundary is a value calculated according to the equation from the pre-training step. The pseudo boundary prediction loss function can be understood as a function that induces a pseudo boundary predicted by an algorithm to be the same as the pseudo boundary. Specifically, it can be understood as performing a binary classification of whether it is a pseudo boundary or not by utilizing the embedding of a shot e_{(i+b*)} corresponding to the pseudo boundary. Through this, the algorithm may learn to distinguish the embedding of a shot corresponding to the pseudo boundary from those that are not corresponding thereto.

The pseudo boundary prediction loss term may be calculated according to the equation shown below, and this may be utilized to learn to accurately predict pseudo boundaries.

$${ℒ}_{PP} = - log ( {h}_{pp} ( {e}_{i + b}^{′} * ) ) - log ( 1 - {h}_{pp} ( e \frac{′}{b} ) ) \qquad [ Equation 8 ]$$

In the above equation, h_{PP} may be defined as a function that converts a shot embedding into a scene boundary probability, and referring to this, it can be seen that the above equation is a loss function that calculates a sum of a log loss term that represents the probability of a shot located on a pseudo boundary to be actually a scene boundary, and a log loss term that represents the probability of a shot that is not a pseudo boundary to be actually not a scene boundary.

Finally, the masked shot modeling loss term may be calculated according to the equation shown below, and this may be utilized to learn to reconstruct hidden shots on the basis of surrounding shots.

$${ℒ}_{M S M} = {‖ {e}_{m} - {h}_{MSM} ( {e}_{m}^{′} ) ‖}_{2}^{2} \qquad [ Equation 9 ]$$

In the above equation, eₘ represents the embedding of a masked shot, h_{MSM}(eₘ′) represents a shot embedding predicted on the basis of surrounding shot embeddings of the masked shot, and L_{MSM} is a loss function obtained by calculating a square of Euclidean distance between two vectors.

The sum of loss terms (loss functions) mentioned above is utilized for calculating a total loss during the pre-learning process, and this can be expressed as shown in the following equation.

$${ℒ}_{pretrain} = {ℒ}_{SSM} + {ℒ}_{CGM} + {ℒ}_{pp} + {ℒ}_{MSM} \qquad [ Equation 10 ]$$

Meanwhile, at the fine-tuning step, variables in the shot encoding unit 130 are fixed, and the global context analysis unit 140 and the scene boundary determination unit 150 are trained. At the fine-tuning step, training is performed by comparing the scene boundary prediction result (prediction) of the scene boundary determination unit 150 with the actual correct answer (ground truth) using the binary cross entropy according to the equation shown below.

$${ℒ}_{finetune} = - {y}_{i} log ( {h}_{C} ( {e}_{i}^{′} ) ) + ( 1 - {y}_{i} ) log ( 1 - {h}_{C} ( {e}_{i}^{′} ) ) \qquad [ Equation 11 ]$$

In the above equation, yᵢ represents a correct answer as to whether the i-th shot is a boundary of scenes, and h_{C}(eᵢ′) represents a probability value obtained by inputting the shot embedding of the i-th shot acquired through the global context analysis unit 140 into the scene boundary determination unit 150.

The scene segmentation method according to the present invention and the system therefor have been described above with reference to the drawings.

Meanwhile, when scenes in a video are accurately segmented according to the present invention, various subsequent utilization examples may exist.

For example, when a user inputs a scene to be searched using text, the system according to the present invention may calculate the similarity between a vector converted from the text and a scene unit vector, and provide scenes highly related to the text as a search result (Text2Scene). As a specific example, when a user inputs “car chase scene” as text for searching, the system according to the present invention may analyze the meaning of the text and search for scene unit vectors having a similar meaning. In addition, when a user inputs an arbitrary image, the system according to the present invention may provide scenes highly related to the image as a search result (Image2Scene). For example, when a user inputs a specific still image as an image for searching, the system according to the present invention may analyze visual characteristics of the image and search for scene unit vectors similar to the visual characteristics, and provide the scene unit vectors to the user. In addition, the system according to the present invention may be implemented to search for, when a user selects an arbitrary scene from a video, scenes having characteristics similar to those of the selected scene (Scene2Scene). At this point, similar characteristics may include the atmosphere of the scene, the context of the scene, the characters appearing in the scene, and the like.

As another example of utilization, when scenes in a video can be segmented and identified according to the present invention, it may be utilized for automation of rating the contents. Since whether harmful or inappropriate scenes are contained in a video can be determined through determination of similarity with scene unit vectors, this may be effective in rating a vast amount of video contents.

As still another example of utilization, the system according to the present invention may be utilized to perform a function of recommending a good time point of exposing specific advertising contents by comparing and analyzing scene unit vectors. That is, when scene unit vectors are compared with vectors of advertising contents, the similarity between a specific scene and the advertising contents, i.e., the time point at which the context of the advertising contents is similar to that of the specific scene, can be grasped, and thus the overall flow of watching the video is not interrupted, and as these time points are provided to the user (e.g., advertiser), the system may maximize the effect of exposing the advertisement.

Meanwhile, the present invention is not limited to the specific embodiments and application examples described above, and various modifications can be made by those skilled in the art without departing from the gist of the present invention claimed in the claims, and these modifications should not be understood as being distinguished from the technical spirit or prospect of the present invention.

The present invention may automate the task of segmenting a plurality of scenes in a video, and may also has an effect of increasing accuracy of scene segmentation by utilizing context information between adjacent shots.

In addition, as an embedding generated in the scene segmentation process is utilized in generating new video contents, there is an effect of increasing the efficiency in producing secondary contents on the basis of original contents.

### DESCRIPTION OF SYMBOLS

100: System

What is claimed is:

1. A method of segmenting a scene by a system including a central processing unit and a memory, the method comprising the steps of:
(a) receiving video contents;
(b) segmenting a plurality of key frames included in a specific shot of the video contents into a plurality of patches, and generating a patch embedding by vectorizing each patch;
(c) generating a shot embedding that reflects information on a specific shot of the video contents and adjacent shots existing to be adjacent to the specific shot with reference to the patch embedding, wherein the shot embedding is a vector matching the specific shot; and
(d) calculating a probability value that the specific shot corresponds to a scene boundary on the basis of a shot embedding sequence configured of a plurality of consecutive shot embeddings.

2. The method according to claim 1, further comprising, after step (d), the step of (e) determining whether the specific shot corresponds to a scene boundary with reference to the probability value.

3. The method according to claim 1, wherein step (b) includes the steps of:
segmenting each of the plurality of key frames included in a specific shot into a plurality of patches;
generating a patch sequence by embedding the plurality of segmented patches;
generating a patch embedding by adding a class token to the patch sequence; and
adding a position embedding to the patch embedding.

4. The method according to claim 3, wherein step (c) includes the steps of:
extracting intra context of the specific shot using the patch embedding;
extracting inter context between the specific shot and at least one or more adjacent shots existing to be adjacent to the specific shot; and
generating a shot embedding corresponding to the specific shot and representing characteristics of the specific shot and the at least one or more adjacent shots.

5. The method according to claim 4, wherein the intra context is extracted by relationships among the plurality of patches included in the specific shot.

6. The method according to claim 5, wherein the inter context is extracted by relationships between the specific shot and the at least one or more adjacent shots.

7. The method according to claim 6, wherein the step of extracting inter context is performed through a Kuleshov mechanism, wherein the Kuleshov mechanism is a conversion mechanism that reflects a multi-head self-attention (MSA) layer, a multi-layer perception block, a layer normalization, a fully connected layer, and a Kuleshov window.

8. The method according to claim 7, wherein step (d) is a step of receiving a shot embedding sequence as an input, and determining whether each shot is a boundary of a scene using the shot embedding sequence, wherein the shot embedding sequence is a set of a plurality of consecutive shot embeddings.

9. A method of segmenting a scene by a system including a central processing unit and a memory, the method comprising the steps of:
(a) receiving video contents without a scene label;
(b) segmenting a plurality of key frames included in a specific shot of the video contents into a plurality of patches, and generating a patch embedding by vectorizing each patch;
(c) generating a shot embedding that reflects information on a specific shot of the video contents and adjacent shots existing to be adjacent to the specific shot with reference to the patch embedding, wherein the shot embedding is a vector matching the specific shot; and
(d) generating a pseudo boundary by searching for a semantic transition point within a shot sequence using duration information of the specific shot, wherein the shot sequence is configured of a plurality of arbitrary consecutive shots.

10. The method according to claim 9, wherein step (c) includes the steps of:
extracting intra context of the specific shot using the patch embedding;
extracting inter context between the specific shot and at least one or more adjacent shots existing to be adjacent to the specific shot; and
generating a shot embedding corresponding to the specific shot and representing characteristics of the specific shot and the at least one or more adjacent shots.

11. The method according to claim 9, wherein the step of generating a pseudo boundary includes the steps of:
segmenting the shot sequence into two non-overlapping sequences of a first subsequence and a second subsequence;
determining a farther subsequence among the first subsequence and the second subsequence as an anchor shot on the basis of a temporal distance from the specific shot;
calculating an optimal alignment value between the anchor shot and the shot sequence; and
determining a pseudo boundary on the basis of a result of the calculation.

12. The method according to claim 11, further comprising, after step (d), the step of (e) calculating a probability value that the specific shot corresponds to a scene boundary on the basis of a shot embedding sequence configured of a plurality of consecutive shot embeddings.

13. A system including a central processing unit and a memory, the system comprising:
a contents receiving unit for receiving arbitrary video contents from outside;
a patch embedding unit for segmenting a plurality of key frames included in a specific shot of the video contents into a plurality of patches, and generating a patch embedding by vectorizing each patch;
a shot encoding unit for generating a shot embedding that reflects information on a specific shot of the video contents and a plurality of shots including adjacent shots existing to be adjacent to the specific shot with reference to the patch embedding, wherein the shot embedding is a vector matching the specific shot; and
a global context analysis unit for calculating a probability value that the specific shot corresponds to a scene boundary on the basis of a shot embedding sequence configured of a plurality of consecutive shot embeddings.

14. The system according to claim 13, wherein further comprising a scene boundary determination unit for determining whether the specific shot is a scene boundary with reference to a probability value calculated by the global context analysis unit.

15. A system including a central processing unit and a memory, the system comprising:
a contents receiving unit for receiving arbitrary video contents without a scene label from outside;
a patch embedding unit for segmenting a plurality of key frames included in a specific shot of the video contents into a plurality of patches, and generating a patch embedding by vectorizing each patch;
a shot encoding unit for generating a shot embedding that reflects information on a specific shot of the video contents and a plurality of shots including adjacent shots existing to be adjacent to the specific shot with reference to the patch embedding, wherein the shot embedding is a vector matching the specific shot;
a pseudo boundary generation unit for generating a pseudo boundary by searching for a semantic transition point within a shot sequence using duration information of the specific shot, wherein the shot sequence is configured of a plurality of arbitrary consecutive shots; and
a global context analysis unit for calculating a probability value that the specific shot corresponds to a scene boundary with reference to a shot embedding sequence configured of a plurality of consecutive shot embeddings and the pseudo boundary generated by the pseudo boundary generation unit.
